(19) United States
(12) Patent Application Publication
(10) Pub. No.: US 2023/0177083 A1
(43) Pub. Date: Jun. 8, 2023

(54) METHOD AND APPARATUS FOR SIMULTANEOUS VIDEO RETRIEVAL AND ALIGNMENT

(71) Applicant: ELECTRONICS AND TELECOMMUNICATIONS RESEARCH INSTITUTE, Daejeon (KR)

(72) Inventors: Joon Soo KIM, Daejeon (KR); Joung Il YUN, Daejeon (KR); Geun Taek LIM, Daejeon (KR); Won JO, Daejeon (KR); Yu Kyung CHOI, Daejeon (KR); Yu Jin HWANG, Daejeon (KR)

(73) Assignee: ELECTRONICS AND TELECOMMUNICATIONS RESEARCH INSTITUTE, Daejeon (KR)

(21) Appl. No.: 18/072,268

(22) Filed: Nov. 30, 2022

(30) Foreign Application Priority Data
Dec. 6, 2021 (KR) 10-2021-0173248
Jul. 18, 2022 (KR) 10-2022-0087956

(51) Int. Cl. G06F 16/783; G06T 7/194; G06V 10/74; G06V 20/40

(52) U.S. Cl. CPC G06F 16/783; G06T 7/194; G06V 10/761; G06V 20/47

(57) ABSTRACT

Disclosed herein method and apparatus for simultaneous video retrieval and alignment. According to an embodiment of the present disclosure, there is provided a method for retrieving a video. The method comprising: detecting a section of interest in a query video that is a retrieval request video; producing one or more frame-level descriptor and a video-level descriptors for the query video by using key frames within the detected section of interest; and retrieving a reference video corresponding to the query video based on the frame-level descriptor and the video-level descriptor for the query video and one or more frame-level descriptor and a video-level descriptor for each of reference videos stored in a database.

### CROSS REFERENCE TO RELATED APPLICATION

The present application claims priority to Korean patent applications 10-2021-0173248, filed Dec. 6, 2021, and 10-2022-0087956, filed Jul. 18, 2022, the entire contents of which are incorporated herein for all purposes by this reference.

### BACKGROUND OF THE INVENTION

### Field of the Invention

The present disclosure relates to a simultaneous video retrieval and alignment technology and, more particularly, to a video retrieval and alignment method and apparatus that are capable of retrieving a reference video similar to a query video and section information at the same time by selecting a section of interest.

### Description of the Related Art

Information retrieval may be understood as a task of searching for most suitable data in a collection of massive volumes. Information retrieval has been developed from document retrieval using keywords, to image retrieval using query images and then to retrieval of videos that match best through query video clips.

Thanks to the advances of Internet infrastructure, the video streaming industry is being spotlighted more than ever. YouTube, one of the biggest video streaming platforms, has as many as 2 billion users monthly, who spend over 1 billion hours every day on watching video in the platform. The dramatic growth of the video streaming market promotes a demand for more diverse functions in video retrieval tasks. For example, a user may want to find a new video that is most similar to what the user has just watched, another user may want to search for a film including a short video clip that the user watched in an interest preview, and yet another user may want to find an accurate point where a short video clip starts in a whole film like video alignment.

### SUMMARY

A technical object of the present disclosure is to provide a video retrieval and alignment method and apparatus that are capable of retrieving a reference video similar to a query video and section information at the same time by selecting a section of interest.

Other objects and advantages of the present invention will become apparent from the description below and will be clearly understood through embodiments. In addition, it will be easily understood that the objects and advantages of the present disclosure may be realized by means of the appended claims and a combination thereof.

Disclosed herein method and apparatus for simultaneous video retrieval and alignment. According to an embodiment of the present disclosure, there is provided a method for retrieving a video. The method comprising: detecting a section of interest in a query video that is a retrieval request video; producing one or more frame-level descriptor and a video-level descriptors for the query video by using key frames within the detected section of interest; and retrieving a reference video corresponding to the query video based on the frame-level descriptor and the video-level descriptor for the query video and one or more frame-level descriptor and a video-level descriptor for each of reference videos stored in a database.

According to the embodiment of the present disclosure, wherein the detecting of the section of interest detects the section of interest by removing a background section from the query video.

According to the embodiment of the present disclosure, wherein the detecting of the section of interest detects the section of interest in the query video by using a network of a pretrained model that performs object tracking or behavior detection in the query video.

According to the embodiment of the present disclosure, wherein the producing selects first key frames within the detected section of interest, produces spatial feature information of each of the selected first key frames, and produces the frame-level descriptor based on the spatial feature information.

According to the embodiment of the present disclosure, wherein the producing selects second key frames within the detected section of interest, produces spatiotemporal feature information of the selected second key frames, and produces the video-level descriptor based on the spatiotemporal feature information.

According to the embodiment of the present disclosure, wherein the retrieving calculates a similarity between the frame-level descriptor of each of the reference videos and the frame-level descriptor of the query video and retrieves an upper predetermined number of section information based on the calculated similarity.

According to the embodiment of the present disclosure, wherein the retrieving calculates a similarity between the video-level descriptor of the query video and the video-level descriptor of each of the reference videos, retrieves a reference video with the calculated similarity of the video-level descriptor being equal to or above a predetermined similarity, and retrieves the upper predetermined number of section information based on the similarity of the video-level descriptor and the similarity of the frame-level descriptor of the retrieved reference video.

According to another embodiment of the present disclosure, there is provided a method for retrieving a video. The method comprising: receiving a video feature descriptor that comprises one or more frame-level descriptor and a video-level descriptor for a section of interest of a query video that is a retrieval request video; and retrieving a reference video corresponding to the query video based on the frame-level descriptor and the video-level descriptor of the query video and one or more frame-level descriptor and a video-level descriptor for each of reference videos stored in a database.

According to another embodiment of the present disclosure, there is provided an apparatus for retrieving a video. The apparatus comprising: a receiver configured to receive a video feature descriptor that comprises one or more frame-level descriptor and a video-level descriptor for a section of interest of a query video that is a retrieval request video; and a retriever configured to retrieve a reference video corresponding to the query video based on the frame-level descriptor and the video-level descriptor of the query video and one or more frame-level descriptor and a video-level descriptor for each of reference videos stored in a database.

The features briefly summarized above with respect to the present disclosure are merely exemplary aspects of the detailed description below of the present disclosure, and do not limit the scope of the present disclosure.

According to the present disclosure, it is possible to provide a video retrieval and alignment method and apparatus that are capable of retrieving a reference video similar to a query video and section information at the same time by selecting a section of interest.

Effects obtained in the present disclosure are not limited to the above-mentioned effects, and other effects not mentioned above may be clearly understood by those skilled in the art from the following description.

### BRIEF DESCRIPTION OF THE DRAWINGS

FIG. 1 shows an operation flowchart for describing a process of extracting a video feature descriptor from a query video or a database video according to an embodiment of the present disclosure.

FIG. 2 shows an operation flowchart for a method of retrieving and aligning a video in response to a retrieval request of a query video according to another embodiment of the present disclosure.

FIG. 3A to FIG. 3C are an example view for describing a method according to an embodiment of the present disclosure.

FIG. 4 shows a configuration of a user terminal according to an embodiment.

FIG. 5 shows a configuration of a video retrieval apparatus according to another embodiment of the present disclosure.

FIG. 6 shows a configuration of a device to which a video retrieval apparatus is applicable according to another embodiment of the present disclosure.

### DETAILED DESCRIPTION OF THE INVENTION

Hereinafter, exemplary embodiments of the present disclosure will be described in detail with reference to the accompanying drawings so that those skilled in the art may easily implement the present disclosure. However, the present disclosure may be implemented in various different ways, and is not limited to the embodiments described therein.

In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

In the present document, such phrases as ‘A or B’, ‘at least one of A and B’, ‘at least one of A or B’, ‘A, B or C’, ‘at least one of A, B and C’ and ‘at least one of A, B or C’ may respectively include any one of items listed together in a corresponding phrase among those phrases or any possible combination thereof.

The video retrieval technology based on visual information is a type of content-based image/video retrieval, and this is a technology of searching for a video similar to a retrieval request video in a database based on visual feature information of an image or video. A unit of retrieval may be a video file, a region of a video, or a section. Especially, in the case of an untrimmed video dataset where videos do not contain semantically same contents, for example, an action of shooting an arrow, it is useful to carry out section-based retrieval by extracting visual features that differentiate sections with different contents.

A model of suggesting a section of interest like the one where a person takes a specific action from a video dataset is being studied with a view to improving the video-based action detection performance. Meanwhile, from the perspective of extracting a video feature descriptor, such a model for suggesting a section of interest may be used to reduce an overall size of descriptors since it can reduce the number of frames in which features are to be extracted.

Main section detection may consist of a time-space feature extracting module using 3D CNN and a main section suggestion and evaluation module and may be tuned to suggest a section of interest through learning according to a specific standard. For example, a main section detection model may be trained to detect only accident video sections by using FIVR that is a video dataset for various disaster scenes.

MPEG has developed the Compact Descriptors for Video Analysis (CDVA) that is a standard video retrieval technology of extracting visual feature descriptors. The CDVA standard technology defines a process of 1) extracting a global/local descriptor for frames, 2) extracting a descriptor based on deep learning, 3) determining an encoding order of frame descriptors, and 4) encoding frame descriptors, and a CDVA descriptor produced by the procedure includes a collection of global/local/deep feature descriptors for individual frames.

Although a concrete method of video retrieval using a CDVA descriptor is not within the scope of the standard, the reference software released by MPEG implements video retrieval using a CDVA descriptor and segment-level section matching. In the CDVA reference software, the frame similarity is determined by a combination of global/deep feature descriptor similarities, and two types of similarities are combined in different ways according to an operation mode. A similarity between two videos is calculated first as a maximum value among similarities of all the frame pairs, and depending on an operation mode, reranking may be additionally performed based on a local feature descriptor. When a frame pair with a highest similarity is found for two videos, a segment pair including each of the frames may be determined, and when the similarity of this segment pair is equal to or above a predetermined level, it is determined to be a matched pair.

In the CDVA standard, a segment is a unit of performing encoding, and each segment consists of key frames that are sampled in a corresponding video section. Among the frames of an original video, a key frame means a frame for extracting a video feature descriptor, and when a key frame is produced at a sufficient time interval, redundancy of descriptors with almost identical information may be reduced. Except in very extreme key frame sampling conditions, adjacent key frames have a certain level of correlation, and when highly-correlated key frames are bound by a segment, redundancy of key frames may be removed so that efficient encoding may be performed.

The CDVA standard does not provide any specific compulsory algorithm as a concrete method of key frame sampling and segmentation but proposes one implementation method as an informative step. The proposed method is based on simple subsampling, color histogram similarity evaluation, and global feature descriptor similarity evaluation, and this method shows good performance in removing information redundancy but does not consider the relative importance of frame descriptors at all. When preliminary information or additional context is given for distribution of video features of a database, more efficient compression may be performed by allocating more resources to a section of interest that has a relatively higher importance.

The embodiments of the present disclosure are directed to improve video retrieval/alignment performance in relation to the bitrate of a video feature descriptor based on information on a section of interest within a video.

Herein, the video may include a single image or a single frame video.

As video retrieval is based on an operation of evaluating similarity of an video, there should be at least two videos to be analyzed. There are various service scenarios but, for convenience of explanation, the detailed description below will focus on a case of a user's retrieving a reference (R) video, which is similar to a query (Q) video, that is, a feature retrieval video, in a specific database.

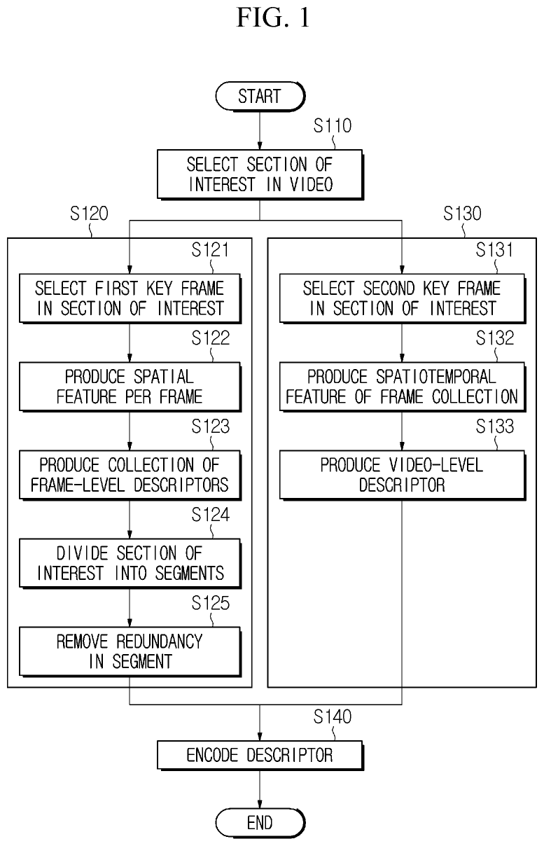

FIG. 1 shows an operation flowchart for describing a process of extracting an video feature descriptor from a query video or a database video according to an embodiment of the present disclosure, and FIG. 1 describes a process of extracting an video feature descriptor for a query video to be retrieved.

Referring to FIG. 1, when video feature descriptor extraction is disclosed for a query video, a section of interest within a video is selected to reduce a size of an video feature descriptor, and when the section of interest within the video is selected or detected, one or more frame-level descriptor and a video-level descriptor are produced by using the selected section of interest (S110, S120, S130).

Herein, at step S110, the section of interest may be detected using a section-of-interest proposal network that is used for object tracking, behavior detection and the like. As an example, the section-of-interest proposal network may include a boundary matching network (BMN), and such a network may be utilized without separate learning or after additional learning to consider a context provided with a retrieval video or a video feature distribution of a database.

According to an embodiment, at step S110, a section of interest may be detected in a query video by removing redundant segments (distractor segments) or background from the query video. Most of the redundant segments may degrade the quality of video-level function representation, and at step S110, in order to rain a model for removing the background, the background may be defined as a segment that can be considered to be a shot transition or be an external content. Herein, the shot transition may include a fade-off effect that is placed between shots, and the external content may include a segment, which is irrelevant either visually or semantically, before and after meaningful video contents. That is, at step S110, a section of interest may be detected from a query video by finding and removing a temporal segment that has little to do with a shot transition or a specific topic. Through the process of step S110, the query video may be composed only of contents that are meaningful since many different topics are successively connected. According to an embodiment, at step S110, a background section is identified by selecting, based on visual meaning information, candidates irrelevant to a video-level topic, and thus a section of interest of the query video may be detected.

As for a process of producing one or more frame-level descriptor by using the selected section of interest, the process of producing one or more frame-level descriptor (S120) selects first key frames within the selected section of interest, produces spatial features per the selected frame, performs segmentation for the section of interest, and then removes redundancy within a segment thus divided (S121 to S125).

Specifically, after a section of interest is selected, a key frame (first key frame) for producing one or more frame-level descriptor within the section of interest may be sampled in a way of preventing excessive redundancy.

A spatial feature is independently produced for each of first key frames, and the spatial feature may include a collection of local features like SIFT or a collection of feature maps based on a deep learning network. Spatial feature information is represented by a video feature descriptor that enables a mutual similarity score to be quickly and easily calculated, and a HOG (Histogram of Oriented Gradients) descriptor for local features or a global feature descriptor, which summarizes a statistical distribution of a description collection by a Fisher vector, belongs to such a descriptor category. For convenience of explanation, the description below is based on a case of using an MPEG CDVS descriptor as one or more frame-level descriptor.

After producing one or more frame-level descriptor, a section of interest may be divided again into units of performing compression encoding. That is, the section of interest may be divided into segments. Frames adjacent in time within a video frequently contain similar contents, and thus frame-level descriptors of different key frames have a high degree of correlation in many cases. Accordingly, when a section of interest is divided again into time periods maintaining a high correlation, a compression gain may be obtained by removing redundancy between frames. On the other hand, it is necessary to ensure that, when a section is divided, frame-level descriptors within each segment have a certain level of similarity, and to this end, like the CDVA standard, a color histogram of frames or a similarity score of frame-level descriptors needs to be referenced.

As for a process of producing a video-level descriptor by using a selected section of interest, the process of producing a video-level descriptor (S130) selects second key frames within the selected section of interest, extracts a spatiotemporal feature of a frame collection and then produces a video-level descriptor (S131 to S133).

Specifically, after the section of interest is selected, a key frame (second key frame) for producing a video-level descriptor within the section of interest may be selected by a frame selection method, which is used to learn a spatiotemporal feature extraction network, or any other frame selection method with an equivalent effect.

The second key frames are first grouped into a unit that can be input into a spatiotemporal feature extraction model. The spatiotemporal feature extraction model may be implemented by using a 3D convolutional neural network (CNN) or a transformer including a temporal attention operation and include a multi-fiber network (MF-Net) or a TimeSformer network, for example. The spatiotemporal feature extraction model should be capable of finally producing a video-level descriptor that expresses a temporal feature of second key frames and has a fixed length, and the model may be subject to a learning process for reducing a distance between similar videos by utilizing a distance function between predefined descriptors and for increasing a distance between dissimilar videos.

When one or more frame-level descriptor and a video-level descriptor are produced through the above-described process, the frame-level descriptor and the video-level descriptor may be encoded into a binary bitstream (S140).

Herein, at step S140, for frame-level descriptors, prediction encoding may be performed in a segmentation unit divided at step S124, and a representative descriptor value of each segment or a descriptor generated through temporal interpolation may be used as a descriptor prediction value. Furthermore, the encoding process of step S140 may include an entropy encoding process.

The above-described process of extracting a video feature descriptor may also be performed for videos in a database, that is, reference videos, and when performing a descriptor encoding process according to the resource and environment of a database, an encoded descriptor for each reference video may be stored, and by skipping the descriptor encoding process, a video-level descriptor and one or more frame-level descriptor for each reference video may be stored. That is, for similarity comparison with a query video descriptor, a descriptor for a reference video within a database should be extracted by using a technique that is compatible with and forms a pair with a retrieval video descriptor extraction technique, and a completely same technique may generally be used to extract a retrieval video descriptor and a database video descriptor.

Herein, in the case of a reference video within a database, selecting a section of interest may be skipped by considering trade-off between storage and retrieval success rate.

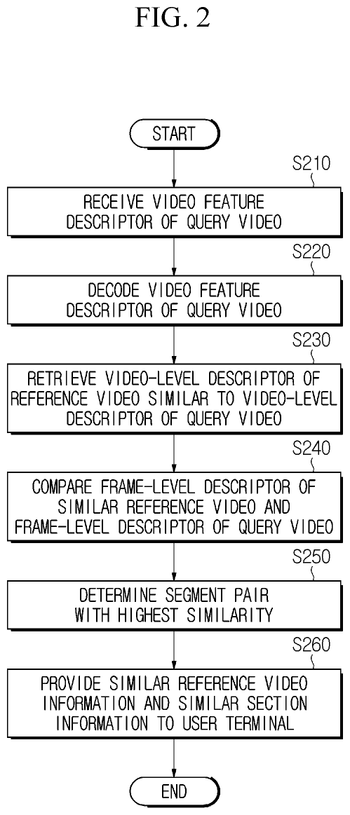

FIG. 2 shows an operation flowchart for a method of retrieving and aligning a video in response to a retrieval request of a query video according to another embodiment of the present disclosure, and FIG. 2 assumes that, when video feature descriptors of a reference video within a database are encoded and stored, they are all decoded to enable immediate similarity comparison.

Referring to FIG. 2, in a video retrieval and alignment method according to a retrieval request of a query video according to another embodiment of the present disclosure, when a decoded video feature descriptor for a query video to be retrieved is received from a user terminal, a video feature descriptor of the query video is decoded, and when the video feature descriptor of the query video is decoded, a similar video-level descriptor is retrieved among video-level descriptors of a reference video within the database based on a video-level descriptor of the query video (S210, S220, S230).

Herein, at step S230, a similarity is calculated between the video-level descriptor of the query video and a video-level descriptor of each of reference videos stored in the database, and a reference video with a calculated similarity equal to or above a predetermined one may be retrieved.

A reference video similar to the query video is retrieved through step S230, and in case only a similar reference video is to be provided, information on the similar reference video, for example, a list of a predetermined number (e.g., M) of reference videos with video-level descriptors having high similarity may be provided to a user terminal that requests retrieval of the query video.

On the other hand, in case not only video-level retrieval but also section-level alignment is required, frame-level descriptors of a retrieved reference video and frame-level descriptors of the query video may be compared, and when a frame pair with high similarity is determined by combining similarity of a video-level descriptor and similarity of frame-level descriptors, a time stamp of a section, to which the frame belongs, and a name of a similar video may be provided to the user terminal (S240, S250, S260).

Herein, at step S260, when section information is provided, by determining a segment pair through a determined frame pair, information on a predetermined number (e.g., top N) of sections with high similarity may be provided to the user terminal.

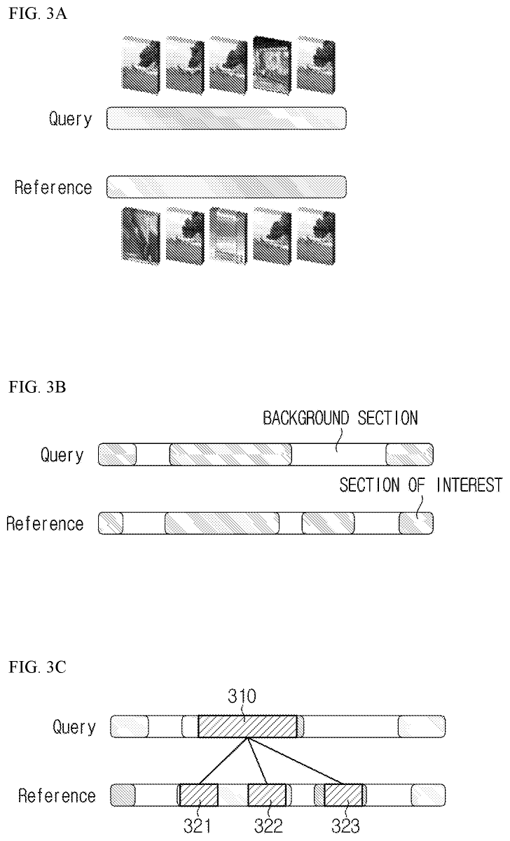

A video retrieval and alignment method according to an embodiment of the present disclosure will be described below with reference to FIG. 3A to FIG. 3C. As illustrated in FIG. 3A, for a query video that is a retrieval request video and reference videos stored in a database respectively, a section of interest is detected as illustrated in FIG. 3B. Herein, in each of the query video and the reference videos, the section of interest may be detected by detecting a background section and removing the detected background section.

In addition, for a video in which a section of interest is detected or determined, by selecting first key frames and second key frames, one or more frame-level descriptor using spatial feature information of the first key frames respectively and a video-level descriptor using spatiotemporal feature information of the second key frames are produced so that a video feature descriptor may be produced for each of the query video and the reference videos. Of course, when a user terminal requests video retrieval for the query video, a video feature descriptor for the query video may be produced by using the query video, and each of the reference videos stored in a database may be stored by producing a video feature descriptor for each of the reference videos. Of course, a video feature descriptor of a reference video stored in a database may be stored by being encoded or be stored as it is.

As illustrated in FIG. 3C, the produced video feature descriptor of the query video may be compared with a video feature descriptor of a reference video to calculate a similarity, and based on the similarity thus calculated, it is possible to determine not only an upper predetermined number of reference videos similar to the query video but also an upper predetermined number of segment pairs with a high similarity, for example, the segment pairs (310, 321), (310, 322) and (310, 323) of the query video and a reference video.

A similar reference video and similar section information, which are determined through the above-described process, may be provided to a user terminal that requests retrieval of a query video.

Thus, a method according to an embodiment of the present disclosure may have high retrieval performance as compared to a transmission bitrate by introducing selection of a section of interest and perform section-level retrieval quickly and accurately by utilizing video-level descriptor based similar video retrieval and by performing alignment only for videos that are primarily selected.

Furthermore, a method according to an embodiment of the present disclosure may select not only a reference video with a high similarity but also information on a similar section by using a neural network of a pretrained learning model.

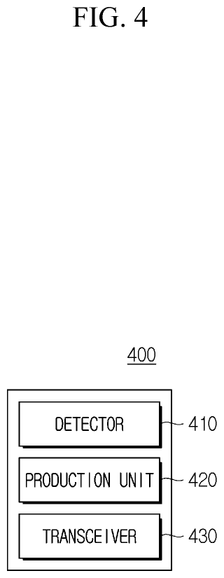

FIG. 4 shows a configuration of a user terminal according to an embodiment.

Referring to FIG. 4, a user terminal 400 includes a detector 410, a production unit 420, and a transceiver 430. Of course, the user terminal 400 may further include a basic configuration of the user terminal like a display unit and a memory, along with the above-described configuration.

The detector 410 detects a section of interest in a query video.

Herein, the detector 410 may detect the section of interest by using a section-of-interest proposal network that is used for such a purpose as object tracking or behavior detection or may detect the section of interest in the query video by removing redundant segments (distractor segments) or background from the query video.

The production unit 420 produces a video feature descriptor including one or more frame-level descriptor and one or more frame-level descriptor of the query video by using key frames of the section of interest of the query video.

Herein the production unit 420 may select first key frames within the selected section of interest, produce spatial features per the selected frame, perform segmentation for the section of interest, produce one or more frame-level descriptor of the query video by removing redundancy within a segment thus divided, and select second key frames within the selected section of interest, extract a spatiotemporal feature of a frame collection and then produce a video-level descriptor of the query video based on spatiotemporal feature information of the second key frames.

The transceiver 430 encodes and provides the video feature descriptor of the query video to a video retrieval server performing video retrieval, receives a section retrieval result according to the need of a video retrieval result in the video retrieval server and then displays the section retrieval result on the user terminal.

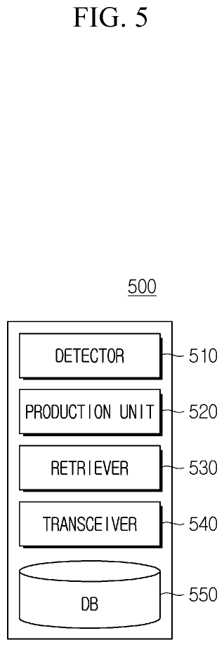

FIG. 5 shows a configuration of a video retrieval apparatus according to another embodiment of the present disclosure, and the video retrieval apparatus may correspond to a video retrieval server, and a configuration of this video retrieval server is shown.

Referring to FIG. 5, a video retrieval apparatus 500 according to another embodiment of the present disclosure includes a detector 510, a production unit 520, a retriever 530, a transceiver 540, and a database (DB) 550.

The DB 550 stores every type of data that is needed in a video retrieval apparatus according to an embodiment of the present disclosure. For example, the DB 550 may store information on reference videos, video feature descriptors (e.g., one or more frame-level descriptor and a video-level descriptor) produced for reference videos respectively, and each of the reference videos.

The detector 510 detects a section of interest for each of the reference videos stored in the DB 550. Herein, when video feature descriptors for each of the reference videos are produced for every video section, a configuration for the detector may be omitted.

Herein, the detector 510 may detect the section of interest by using a section-of-interest proposal network that is used for such a purpose as object tracking or behavior detection or may detect the section of interest in each of the reference videos by removing redundant segments (distractor segments) or background from the query video.

The production unit 520 produces a video feature descriptor including one or more frame-level descriptor and one or more frame-level descriptor of the query video by using key frames of the section of interest in each of the reference videos.

Herein the production unit 520 may select first key frames within the selected section of interest, produce spatial features per the selected frame, perform segmentation for the section of interest, produce one or more frame-level descriptor for each of the reference videos by removing redundancy within a segment thus divided, and select second key frames within the selected section of interest, extract a spatiotemporal feature of a frame collection and then produce a video-level descriptor of each of the reference videos based on spatiotemporal feature information of the second key frames.

The video feature descriptor including one or more frame-level descriptor and one or more frame-level descriptor of each of the reference videos may be encoded and be stored in the DB 550 or be stored in the DB 550 without being encoded. Although not shown in FIG. 5, a storage unit may be further included to store the video feature descriptor, which includes one or more frame-level descriptor and a video-level descriptor produced for each of the reference videos in the DB 550.

When a decoded video feature descriptor for the query video is received through the transceiver 540, the transceiver decodes the video feature descriptor of the query video, and when the video feature descriptor of the query video is decoded, a reference video corresponding to the query video is retrieved based on a video-level descriptor and one or more frame-level descriptor of each of the reference videos stored in the video-level descriptor and frame-level descriptor of the query video.

Herein, the retriever 530 calculates a similarity between the video-level descriptor of the query video and a video-level descriptor of each of reference videos stored in the DB 550, and a reference video with a calculated similarity equal to or above a predetermined one may be retrieved.

Furthermore, when a reference video similar to the query video is retrieved, the retriever 530 may compare frame-level descriptors of the retrieved reference video and frame-level descriptors of the query video, determine a frame pair with high similarity by combining similarity of a video-level descriptor and similarity of frame-level descriptors and thus retrieve a predetermined number of pieces of section information with high similarity.

The transceiver 540 receives and provides a decoded video feature descriptor for the query video to the retriever 530 and provides a retrieval result retrieved by the retriever 530, for example, similar reference video information for the query video and also a predetermined number of pieces of similar section information to a user terminal that requests video retrieval.

Although not described in the apparatus of FIG. 5, an apparatus according to an embodiment of the present disclosure may include all the contents described in a method of FIG. 1 to FIG. 3, which are apparent to those who have skill in the art.

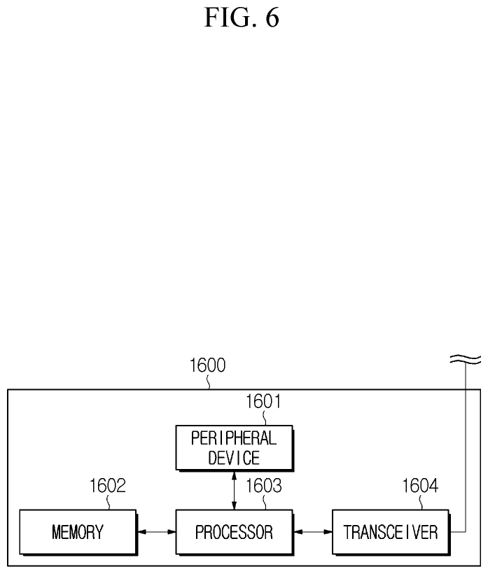

FIG. 6 shows a configuration of a device to which a video retrieval apparatus is applicable according to another embodiment of the present disclosure.

The video retrieval apparatus according to another embodiment of the present disclosure of FIG. 5 may be a device 1600 of FIG. 6. Referring to FIG. 6, the device 1600 may include a memory 1602, a processor 1603, a transceiver 1604 and a peripheral device 1601. In addition, for example, the device 1600 may further include another configuration and is not limited to the above-described embodiment. Herein, for example, the device 1600 may be a mobile user terminal (e.g., a smartphone, a laptop, a wearable device, etc.) or a fixed management device (e.g., a server, a PC, etc.).

More specifically, the device 1600 of FIG. 6 may be an exemplary hardware/software architecture such as a video retrieval device, a video retrieval server, a video service server and a video providing server. Herein, as an example, the memory 1602 may be a non-removable memory or a removable memory. In addition, as an example, the peripheral device 1601 may include a display, GPS or other peripherals and is not limited to the above-described embodiment.

In addition, as an example, like the transceiver 1604, the above-described device 1600 may include a communication circuit. Based on this, the device 1600 may perform communication with an external device.

In addition, as an example, the processor 1603 may be at least one of a general-purpose processor, a digital signal processor (DSP), a DSP core, a controller, a micro controller, application specific integrated circuits (ASICs), field programmable gate array (FPGA) circuits, any other type of integrated circuit (IC), and one or more microprocessors related to a state machine. In other words, it may be a hardware/software configuration playing a controlling role for controlling the above-described device 1600. In addition, the processor 1603 may be performed by modularizing the functions of the detector 510, the production unit 520 and the retriever 530 of FIG. 5.

Herein, the processor 1603 may execute computer-executable commands stored in the memory 1602 in order to implement various necessary functions of the malicious code detection apparatus. As an example, the processor 1603 may control at least any one operation among signal coding, data processing, power controlling, input and output processing, and communication operation. In addition, the processor 1603 may control a physical layer, an MAC layer and an application layer. In addition, as an example, the processor 1603 may execute an authentication and security procedure in an access layer and/or an application layer but is not limited to the above-described embodiment.

In addition, as an example, the processor 1603 may perform communication with other devices via the transceiver 1604. As an example, the processor 1603 may execute computer-executable commands so that the video retrieval apparatus may be controlled to perform communication with other devices via a network. That is, communication performed in the present invention may be controlled. As an example, the transceiver 1604 may send a RF signal through an antenna and may send a signal based on various communication networks.

In addition, as an example, MIMO technology and beam forming technology may be applied as antenna technology but are not limited to the above-described embodiment. In addition, a signal transmitted and received through the transceiver 1604 may be controlled by the processor 1603 by being modulated and demodulated, which is not limited to the above-described embodiment.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

In addition, various embodiments of the present disclosure may be implemented in hardware, firmware, software, or a combination thereof. In the case of implementing the present invention by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

What is claimed is:

1. A method for retrieving a video, the method comprising:
detecting a section of interest in a query video that is a retrieval request video;
producing one or more frame-level descriptor and a video-level descriptors for the query video by using key frames within the detected section of interest; and
retrieving a reference video corresponding to the query video based on the frame-level descriptor and the video-level descriptor for the query video and one or more frame-level descriptor and a video-level descriptor for each of reference videos stored in a database.

2. The method of claim 1, wherein the detecting of the section of interest detects the section of interest by removing a background section from the query video.

3. The method of claim 1, wherein the detecting of the section of interest detects the section of interest in the query video by using a network of a pretrained model that performs object tracking or behavior detection in the query video.

4. The method of claim 1, wherein the producing selects first key frames within the detected section of interest, produces spatial feature information of each of the selected first key frames, and produces the frame-level descriptor based on the spatial feature information.

5. The method of claim 1, wherein the producing selects second key frames within the detected section of interest, produces spatiotemporal feature information of the selected second key frames, and produces the video-level descriptor based on the spatiotemporal feature information.

6. The method of claim 1, wherein the retrieving calculates a similarity between the frame-level descriptor of each of the reference videos and the frame-level descriptor of the query video and retrieves an upper predetermined number of section information based on the calculated similarity.

7. The method of claim 6, wherein the retrieving calculates a similarity between the video-level descriptor of the query video and the video-level descriptor of each of the reference videos, retrieves a reference video with the calculated similarity of the video-level descriptor being equal to or above a predetermined similarity, and retrieves the upper predetermined number of section information based on the similarity of the video-level descriptor and the similarity of the frame-level descriptor of the retrieved reference video.

8. A method for retrieving a video, the method comprising:
receiving a video feature descriptor that comprises one or more frame-level descriptor and a video-level descriptor for a section of interest of a query video that is a retrieval request video; and
retrieving a reference video corresponding to the query video based on the frame-level descriptor and the video-level descriptor of the query video and one or more frame-level descriptor and a video-level descriptor for each of reference videos stored in a database.

9. The method of claim 8, further comprising:
detecting a section of interest in each of the reference videos;
producing one or more frame-level descriptor and a video-level descriptor for each of the reference videos by using key frames in the detected section of interest; and
storing, in the database, the frame-level descriptor and the video-level descriptor that are produced for each of the reference videos.

10. The method of claim 8, wherein the retrieving calculates a similarity between the frame-level descriptor of each of the reference videos and the frame-level descriptor of the query video and retrieves an upper predetermined number of section information based on the calculated similarity.

11. The method of claim 10, wherein the retrieving calculates a similarity between the video-level descriptor of the query video and the video-level descriptor of each of the reference videos, retrieves a reference video with the calculated similarity of the video-level descriptor being equal to or above a predetermined similarity, and retrieves the upper predetermined number of section information based on the similarity of the video-level descriptor and the similarity of the frame-level descriptor of the retrieved reference video.

12. An apparatus for retrieving a video, the apparatus comprising:
a receiver configured to receive a video feature descriptor that comprises one or more frame-level descriptor and a video-level descriptor for a section of interest of a query video that is a retrieval request video; and
a retriever configured to retrieve a reference video corresponding to the query video based on the frame-level descriptor and the video-level descriptor of the query video and one or more frame-level descriptor and a video-level descriptor for each of reference videos stored in a database.

13. The apparatus of claim 12, further comprising:
a detector configured to detect a section of interest in each of the reference videos;
a production unit configured to produce one or more frame-level descriptor and a video-level descriptor for each of the reference videos by using key frames in the detected section of interest; and
a storage unit configured to store, in the database, the frame-level descriptor and the video-level descriptor that are produced for each of the reference videos.

14. The apparatus of claim 13, wherein the production unit is further configured to:
select first key frames within the detected section of interest,
produce spatial feature information of each of the selected first key frames, and
produce the frame-level descriptor based on the spatial feature information.

15. The apparatus of claim 14, wherein the production unit is further configured to:
select second key frames within the detected section of interest,
produce spatiotemporal feature information of the selected second key frames, and
produce the video-level descriptor based on the spatiotemporal feature information.

16. The apparatus of claim 12, wherein the retriever is further configured to:
calculate a similarity between the frame-level descriptor of each of the reference videos and the frame-level descriptor of the query video, and
retrieve an upper predetermined number of section information based on the calculated similarity.

17. The apparatus of claim 16, wherein the retriever is further configured to:
calculate a similarity between the video-level descriptor of the query video and the video-level descriptor of each of the reference videos,
retrieve a reference video with the calculated similarity of the video-level descriptor being equal to or above a predetermined similarity, and
retrieve the upper predetermined number of section information based on the similarity of the video-level descriptor and the similarity of the frame-level descriptor of the retrieved reference video.
